(19) United States
(12) Patent Application Publication
(10) Pub. No.: US 2016/0238161 A1
(43) Pub. Date: Aug. 18, 2016

(54) CLAMPING APPARATUS

(71) Applicant: Caterpillar Inc., Peoria, IL (US)

(72) Inventors: Mark W. Meyer, Pendleton, IN (US); Corey E. Baxter, Lafayette, IN (US); Trevor A. Pease, Lafayette, IN (US)

(73) Assignee: Caterpillar Inc., Peoria, IL (US)

(21) Appl. No.: 15/138,890

(22) Filed: Apr. 26, 2016

(51) Int. Cl. F16L 3/10; F16L 3/137

(52) U.S. Cl. CPC F16L 3/1091; F16L 3/1058; F16L 3/1066; F16L 3/137

(57) ABSTRACT

A clamping apparatus includes a grommet having a slit and adapted to conform to a surface of a tubular member. The clamping apparatus further includes a clamping bracket having a clamping arcuate portion adapted to abut at least a portion of a surface of grommet and a base bracket having a base arcuate portion adapted to abut at least a portion of the surface of the grommet. The clamping bracket further includes at least one recessed portion and at least one clamping bracket hole. The base bracket further includes at least one base bracket hole. The at least one clamping bracket hole is adapted to coaxially align with the at least one base bracket hole to receive a fastening member. The base arcuate portion and clamping arcuate portion define a passageway between the clamping and the base bracket to receive the grommet along with the tubular member coaxially therein.

### TECHNICAL FIELD

The present disclosure relates, in general, to a support structure and, more particularly, to a clamping apparatus for coupling a tubular member to the support structure.

### BACKGROUND

Clamps are used to secure articles, such as tubular members, to a support structure in engines, machines, and in other applications, such as multiple manufacturing facilities. Conventionally, clamps for the tubular members, such as pipes or hoses, are embodied as bent metal straps and are provided with fastening members at either ends of the metal straps to fasten the clamps to the support structure. However, over a period of time, the bend in such clamps and relative movement between the clamps and the tubular member causes wear on a surface of the tubular member, thereby resulting in seepage of fluids flowing through the tubular member. Other conventional clamps, designed to address the seepage of fluid, include a two piece structure. One piece of the clamp is fastened to the other piece in a manner, such that the clamp supports the tubular member between the two pieces. As such, in general, a clamping apparatus is needed to secure the tubular members to the support structure, in addition to protecting the tubular members from any damage.

U.S. Pat. No. 4,270,250 (250 patent) describes a clamping ring assembly for clamping a tubular member. The clamping ring assembly includes two rigid clamping members having semi-circular recesses, one or more annular wedge-shaped grooves in the recesses, and fasteners. An elastomeric insert, or a pair of inserts, has one or more ribs shaped to fit the groove or grooves. The rib height is less than the groove depth leaving an annular gap to improve the clamping action. Inserts of different thickness can be provided to accommodate hoses of different dimensions. Although the inserts of the clamping ring assembly of the '250 patent addresses the problem related seepage of the fluid, the clamping ring assembly of the '250 patent are associated with certain other problems. For instance, head portion of the fasteners used to attach the clamping members are embedded within the clamping member, thus making the head portion inaccessible for engaging a torqueing member. In such a case, commonly used tools for torqueing the fasteners may need to be replaced with high-end tools to torque the fasteners for assembling the clamping members.

### SUMMARY OF THE DISCLOSURE

In one aspect of the present disclosure, a clamping apparatus for clamping a tubular member to a support structure is provided. The clamping apparatus includes a grommet having a slit and adapted to conform on the surface of the tubular member. The clamping apparatus further includes a clamping bracket, The clamping bracket includes a first end including a clamping arcuate portion adapted to abut at least a portion of a surface of the grommet. The clamping bracket further includes a second end distal to the first end. The second end includes at least one recessed portion having a first surface and a second surface. The clamping bracket further includes at least one second hole located at a predetermined distance from the first surface and extending from the second surface to the first end of the clamping bracket. The clamping apparatus further includes a base bracket disposed proximal to the support structure and adapted to engage with the clamping bracket. The base bracket includes a first end adapted to abut a surface of the support structure and a second end distal to the first end. The second end includes a base arcuate portion adapted to abut at least a portion of the surface of the grommet. The base bracket further includes at least one base bracket hole extending from the first end and the second end of the base bracket. The at least one clamping bracket hole is adapted to align with the at least one base bracket hole to receive at least one fastening member therein to engage the clamping bracket with the base bracket. The clamping arcuate portion and the base arcuate portion define a passageway between the clamping bracket and the base bracket to receive the grommet along with the tubular member coaxially therein.

Other features and aspects of this disclosure will be apparent from the following description and the accompanying drawings.

### BRIEF DESCRIPTION OF THE DRAWINGS

FIG. 1 is a perspective view of a portion of a piping layout including a clamping apparatus, according to an embodiment of the present disclosure;

FIG. 2 is a cross-sectional view of the clamping apparatus; and

FIGS. 3 to 5 illustrates an assembly operation of the clamping apparatus, in accordance with the concepts of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

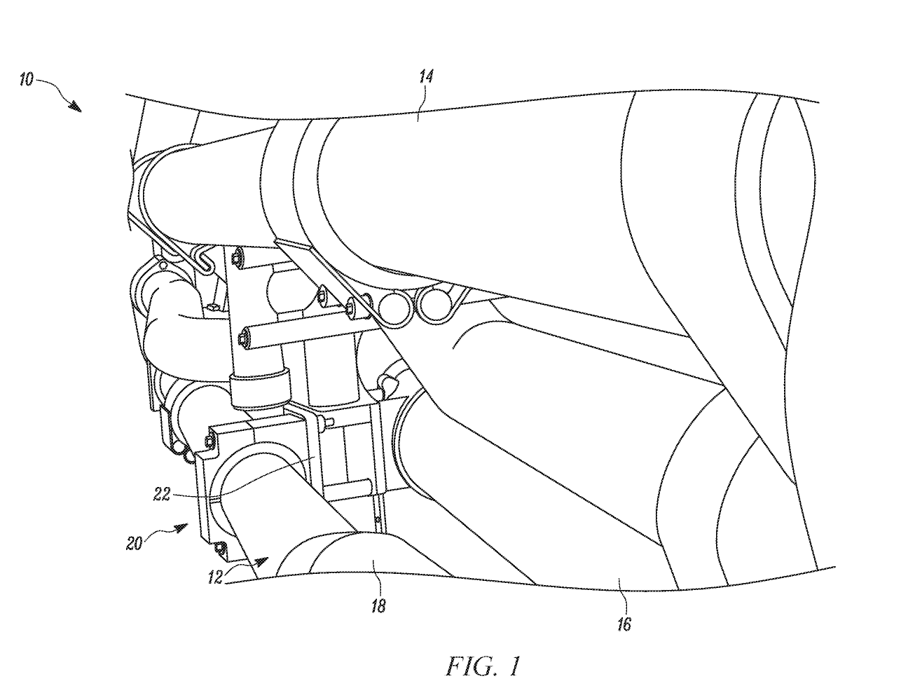

Referring to FIG. 1, a piping layout 10 includes multiple tubular members 12, such as a first pipe 14, a second pipe 16, and a third pipe 18, coupled between a fluid source (not shown) and a supply port (not shown). The tubular members 12 are positioned parallel to each other and arranged in a compact manner, as shown in FIG. 1, so that the piping layout 10 occupies minimum space in a worksite. In order to support each of the tubular members 12, a clamping apparatus 20 is used at a predetermined location along a length of each of the tubular members 12. The clamping apparatus 20 is attached to a support structure 22 that provides support and accommodates the clamping apparatus 20 to be attached thereon. In one example, the support structure 22 may be a bracket, housing, a chassis frame, or a wall in the piping layout 10.

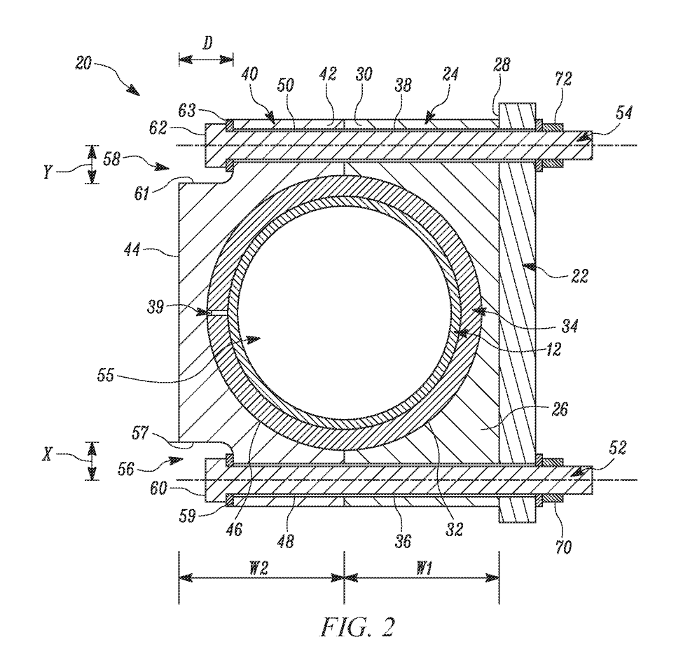

Referring to FIG. 2, a cross-section of the clamping apparatus 20 is shown The clamping apparatus 20 includes a base bracket 24 that is disposed proximal to the support structure 22. In other words, the base bracket 24 is attached to the support structure 22. The base bracket 24 is adapted to engage with a clamping bracket 40. Further, the base bracket 24 includes a first end 26 adapted to abut a surface 28 of the support structure 22. In one example, the first end 26 of the base bracket 24 may include a contour and a corresponding contour may be provided on the surface 28 of the support structure 22 to allow the base bracket 24 to abut or engage with the surface 28 of the support structure 22. The base bracket 24 further includes a second end 30 distal to the first end 26. The first end 26 and the second end 30 define a width ‘W1’ of the base bracket 24. Further, the second end 30 includes a base arcuate portion 32. In one example, the base bracket 24 may be a block having a rectangular cross-section and the base arcuate portion 32 may be formed at the second end 30 of the base bracket 24. The base bracket 24 further includes a pair of base bracket holes extending between the first end 26 and the second end 30 of the base bracket 24. The pair of base bracket holes includes a first base bracket hole 36 and a second base bracket hole 38, as shown in FIG. 2.

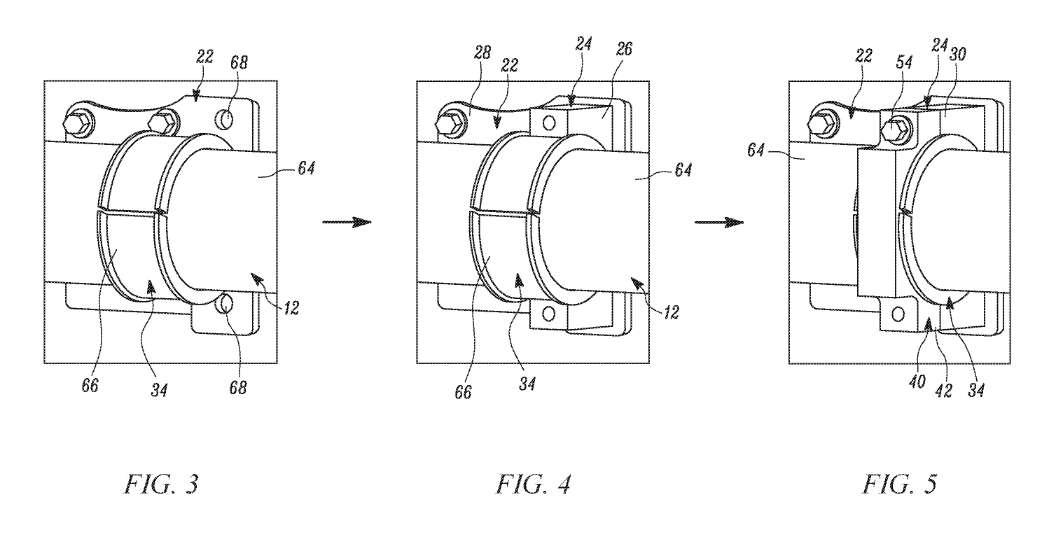

The clamping apparatus 20 also includes a grommet 34 that has a slit 39. In an example, the grommet 34 may be made of an elastic member, such as rubber. The grommet 34 is embodied as a cylindrical structure, where the slit 39 is provided on a periphery of the grommet 34. Accordingly, a surface 66 (shown in FIG. 3) of the grommet 34 conforms to the base arcuate portion 32 of the base bracket 24, when the grommet 34 is engaged with the base bracket 24. The slit 39 may be understood as a cutout on the periphery and along an axis of the grommet 34. As it would be understood, the slit 39 defines a pair of mating surfaces. Owing to the presence of the slit 39, the grommet 34 can be stretched in a manner, such that one mating surface moves away from the other. As such, the slit 39 allows expansion of the grommet 34. With such construction, the grommet 34 is adapted to conform to an outer surface 64 (shown in FIG. 3) of the tubular member 12. For example, the grommet 34 can be stretched and disposed coaxially on the tubular member 12 at the predetermined location along the length of the tubular member 12.

The clamping apparatus 20 further includes a clamping bracket 40 to engage with the base bracket 24. The clamping bracket 40 includes a first end 42 and a second end 44 distal to the first end 42. In one example, the clamping bracket 40 may also be a block having a rectangular cross-section. The first end 42 and the second end 44 define a width ‘W2’ of the clamping bracket 40. The first end 42 of the clamping bracket 40 includes a clamping arcuate portion 46 to abut at least a portion of the surface 66 of the grommet 34. The clamping bracket 40 further includes a pair of clamping bracket holes. The pair of clamping bracket holes include a first clamping bracket hole 48 and a second clamping bracket hole 50. The pair of clamping bracket holes of the clamping bracket 40 is aligned with the pair of base bracket holes of the base bracket 24. In an aligned condition of the pair of base bracket holes and clamping bracket holes, the first base bracket hole 36 is aligned with the first clamping bracket hole 48 to receive a first fastening member 52 and the second base bracket hole 38 is aligned with the second clamping bracket hole 50 to receive a second fastening member 54. In an engaged condition of the clamping apparatus 20, the clamping bracket 40 is attached with the base bracket 24. Additionally, the first end 42 of the clamping bracket 40 abuts the second end 30 of the base bracket 24. Further, in the engaged condition, the base arcuate portion 32 and the clamping arcuate portion 46 define a passageway 55 between the clamping bracket 40 and the base bracket 24 to receive the tubular member 12 coaxially therein. As mentioned earlier, the grommet 34 functions as an intermediary member between the tubular member 12, and the base bracket 24 and the clamping bracket 40.

The second end 44 of the clamping bracket 40 includes a first recessed portion 56 and a second recessed portion 58. The first recessed portion 56 and the second recessed portion 58 may be understood as cut-outs provided at either sides of the second end 44 of the clamping bracket 40. As such, the first recessed portion 56 and the second recessed portion 58 lie at a depth ‘D’ from the second end 44 of the clamping bracket 40. However, it will be understood that, based on dimensional characteristics of the support structure 22 and a length of each of the first fastening member 52 and the second fastening member 54, depth ‘D’ and a width of the first recessed portion 56 and the second recessed portion 58 may differ from the second end 44 of the clamping bracket 40. The depth ‘D’ and width of the first and the second recessed portions 56 and 58 may differ. The first recessed portion 56 includes a first surface 57 and a second surface 59. The first clamping bracket hole 48 is located at a predetermined distance ‘X’ from the first surface 57. Further, the first clamping bracket hole 48 extends from the second surface 59 to the first end 42 of the clamping bracket 40. Similarly, the second recessed portion 58 includes a first surface 61 and a second surface 63. Accordingly, the second clamping bracket hole 50 is located at a predetermined distance ‘Y’ from the first surface 61, and the second clamping bracket hole 50 extends from the second surface 63 to the first end 42 of the clamping bracket 40. The first recessed portion 56 accommodates a head portion 60 of the first fastening member 52 and the second recessed portion 58 accommodates ahead portion 62 of the second fastening member 54.

FIGS. 3 to 5 illustrates the assembly operation of the clamping apparatus 20. Initially, the predetermined location at which the tubular member 12 needs to be clamped is identified. Subsequently, at the predetermined location, the grommet 34 is expanded with the help of the slit 39. In an expanded condition, the grommet 34 is coaxially inserted on the tubular member 12, such that an inner surface not shown) abuts the outer surface 64 of the tubular member 12. When released, the grommet 34 contracts, such that the mating surfaces defined by the slit 39 approach each other to receive the tubular member 12 coaxially therein, as shown in FIG. 3. Subsequently, the base bracket 24 is positioned between the grommet 34 and the support structure 22, such that the base arcuate portion 32 is coaxially aligned with the surface 66 of the grommet 34. In addition, the first end 26 of the base bracket 24 abuts the surface 28 of the support structure 22. Furthermore, the base bracket 24 is positioned, such that the first base bracket hole 36 and the second base bracket hole 38 of the base bracket 24 aligned with holes 68 provided in the support structure 22.

Subsequently, the clamping bracket 40 is positioned on the grommet 34, such that the clamping arcuate portion 46 abuts the surface 66 of the grommet 34 and the first end 42 of the clamping bracket 40 abuts the second end 30 of the base bracket 24. Further, the first fastening member 52 and the second fastening member 54 is inserted into the aligned holes for fastening the clamping apparatus 20 to the support structure 22. For instance, a first nut 70 (as shown in FIG. 2) may be used to fasten the first fastening member 52 and a second nut 72 may be used to fasten the second fastening member 54. In one example, the first fastening member 52 and the second fastening member 54 may be inserted into the aligned holes from the support structure's 22 side, such that the head portion 60, 62 lie behind the support structure 22 and the nuts 70, 72 may lie in the recessed portions 56, 58. In another example, strut bolts may also be used to fasten the first fastening member 52 and the second fastening member 54.

The present disclosure describes engaging of the clamping bracket 40 and the base bracket 24 with aid of the pair of base bracket holes in the base bracket 24, the pair of clamping bracket holes in the clamping bracket 40, the first fastening member 52, and the second fastening member 54. However, it will be understood by a person skilled in the art that the base bracket 24 may include at least one base bracket hole, clamping bracket 40 may include at least one clamping bracket hole. In such a condition, at least one fastening member may be employed to engage the base bracket 24 with the clamping bracket 40.

Various embodiments disclosed herein are to be taken in the illustrative and explanatory sense, and should in no way be construed as limiting of the present disclosure.

### INDUSTRIAL APPLICABILITY

The present disclosure describes the clamping apparatus 20 for attaching the tubular members 12 with the support structure 22 of the piping layout 10. Owing to the first and second recessed portions 56 and 58, the head portions 60 and 62 of the first and second fastening members 52 and 54, respectively, are exposed outside the clamping apparatus 20, which was otherwise embedded within the clamping bracket 40. In addition, such first recessed portion 56 and the second recessed portion 58 allows torqueing of the first fastening member 52 and the second fastening member 54, respectively, with minimum efforts, which otherwise required special tools and additional efforts for torqueing.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A clamping apparatus for clamping a tubular member to a support structure, the clamping apparatus comprising:
a grommet having a slit, the grommet adapted to conform on the surface of the tubular member;
a clamping bracket including:
a first end including a clamping arcuate portion adapted to abut at least a portion of a surface of the grommet;
a second end distal to the first end, the second end includes at least one recessed portion having a first surface and a second surface;
at least one clamping bracket hole located at a predetermined distance from the first surface and extending from the second surface to the first end of the clamping bracket; and
a base bracket disposed proximal to the support structure and adapted to engage with the clamping bracket, the base bracket including:
a first end adapted to abut a surface of the support structure;
a second end distal to the first end, the second end includes a base arcuate portion adapted to abut at least a portion of the surface of the grommet; and
at least one base bracket hole extending from the first end to the second end of the base bracket,
wherein the at least one clamping bracket hole is adapted to coaxially align with the at least one base bracket hole to receive at least one fastening member therein to engage the clamping bracket with the base bracket; and
wherein the clamping arcuate portion and the base arcuate portion define a passageway between the clamping bracket and the base bracket to receive the grommet along with the tubular member coaxially therein.
